(19) United States
(12) Patent Application Publication
(10) Pub. No.: US 2013/0169805 A1
(43) Pub. Date: Jul. 4, 2013

(54) DEVICE FOR PREVENTING DIFFUSED REFLECTION OF LIGHTING FOR PHOTOGRAPHY USING A MONITORING CAMERA

(71) Applicant: Hee-Young Park, Incheon (KR)

(72) Inventor: Hee-Young Park, Incheon (KR)

(73) Assignee: CNB TECHNOLOGY INC., Seoul (KR)

(21) Appl. No.: 13/821,796

(22) PCT Filed: Sep. 9, 2011
(86) PCT No.: PCT/KR2011/006729

§ 371 Date: Mar. 8, 2013

(30) Foreign Application Priority Data
Sep. 16, 2010 (KR) 10-2010-0091018

(51) Int. Cl. H04N 7/18

(52) U.S. Cl. CPC H04N 7/18
USPC 348/143

(57) ABSTRACT

The present invention relates to a device for preventing diffused reflection of lighting for photography using a monitoring camera. Specifically, in a monitoring camera to which IR LED lighting for night-time surveillance is applied, a diffused reflection region of the IR LED due to a rotating motion of a camera lens part may be moved to secure a wide viewing angle. The device for preventing diffused reflection includes: a light emitting diode (LED) lighting part including a plurality of infrared (IR) LEDs disposed along a circular ring part at a predetermined interval and forming a blocking region in which no IR LEDs are installed to match an insertion region within the housing when the LED lighting part is rotated at a maximum angle due to vertical rotation of the vertical rotation bracket; and a lighting part bracket in which the LED lighting part is accommodated and is fixed and which is horizontally rotated clockwise/counterclockwise so that the blocking region formed in the LED lighting part exists within the housing when the camera body is multi-axis rotated for monitoring.

### TECHNICAL FIELD

The present invention relates to a device for preventing diffused reflection of lighting for photography using a monitoring camera, whereby factors of diffused reflection caused by lighting for photography due to a rotating motion of a camera lens part of a closed circuit television (CCTV) monitoring camera that is capable of 4-axis driving may be removed to secure a wide viewing angle.

### BACKGROUND ART

In general, a monitoring camera is used to prevent an unlawful act or robbery in a particular place including a house, such as a parking lot, a department store, a bank, or an exhibition hall. Such a monitoring camera is classified into a stationary camera that detects only a predetermined region, and an active camera using a pan tilt motor that monitors a wide region.

In the stationary camera in which a change of direction is not possible, when a plurality of regions are monitored in one space, a plurality of cameras should be installed. Thus, the active camera is mainly used. Also, a speed dome camera that monitors all over the place by multi-axis rotating a camera in a horizontal direction and in a vertical direction has been developed and is widely used.

The speed dome camera can be rotated in an infinite manner or in a restricted manner at a maximum angle of 360° in the horizontal direction (PAN) that corresponds to the X-axis direction and simultaneously, can be rotated at a maximum angle of 90° or 180° in the vertical direction (TILT) that corresponds to the Y-axis direction. Thus, only one speed dome camera can capture and monitor all over the place in a particular space without arranging a plurality of stationary monitoring cameras.

Such a speed dome camera is of a multi-axis rotation driving type in which a body of a camera can be rotated in the X-axis direction or the Y-axis direction and a lens part of the camera can be infinitely rotated in the X-axis direction at an angle of 360°. Also, in the speed dome camera, a plurality of infrared (IR) light emitting diodes (LEDs) are arranged at the lens part of the camera along a circular part of a lens so that a monitoring function can be normally used even at night. Thus, IR light can be generated to be used for lighting for photography of the lens part.

A monitoring camera to which the speed dome camera is applied, is fixedly mounted on a ceiling or wall of a building and is implemented as a dome type camera in which a protection transparent hemisphere is installed at a housing in which various motors and a circuit board are embedded, so that a portion where a camera driving body protrudes can be protected by the protection transparent hemisphere.

However, in such a monitoring dome type camera according to the related art, when a rotation angle in the vertical direction is adjusted so as to adjust a viewing angle of the camera lens part, some of IR LEDs that are arranged along the circular part of the camera lens part may escape from the transparent hemisphere and may be moved to an inner side of the housing. In this case, since IR light is reflected by the body and disturbs a viewing angle for photography, diffused reflection in which strong IR light is irradiated on an image to be monitored, occurs, and this is an obstacle to night-time surveillance. Thus, since the operating range of the camera should be reduced so as to avoid diffused reflection, a region to be monitored is inevitably limited.

### DETAILED DESCRIPTION OF THE INVENTION

### Technical Problem

The present invention provides a device for preventing diffused reflection of lighting for photography using a monitoring camera, whereby a diffused reflection region of an infrared (IR) light emitting diode (LED) due to a rotating motion of a camera lens part of a monitoring camera to which lighting of the IR LED for night-time surveillance is applied, may be removed to secure a wide viewing angle.

### Technical Solution

According to an aspect of the present invention, there is provided a device for preventing diffused reflection of lighting for photography using a monitoring camera in which a camera body in which horizontal rotation of a lens part bracket including a lens part clockwise/counterclockwise, vertical rotation of a vertical rotation bracket and horizontal rotation of a horizontal rotation bracket clockwise/counterclockwise are performed, is fixed to a housing, the device including: a light emitting diode (LED) lighting part including a plurality of infrared (IR) LEDs disposed along a circular ring part at a predetermined interval and forming a blocking region in which no IR LEDs are installed to match an insertion region within the housing when the LED lighting part is rotated at a maximum angle due to vertical rotation of the vertical rotation bracket and a lighting part bracket in which the LED lighting part is accommodated and is fixed and which is horizontally rotated clockwise/counterclockwise so that the blocking region formed in the LED lighting part exists within the housing when the camera body is multi-axis rotated for monitoring.

### DESCRIPTION OF THE DRAWINGS

FIG. 1 is an exploded perspective view of a structure of a 4-axis monitoring camera to which a device for preventing diffused reflection of lighting for photography according to an embodiment of the present invention is applied;

FIG. 2 is a perspective view of a combined 4-axis driving state of the 4-axis monitoring camera to which the present invention is applied;

FIG. 3 is a view of a state in which the 4-axis monitoring camera to which the present invention is applied, is fixedly installed at a housing;

FIG. 4 is a view of a structure for preventing diffused reflection of an infrared (IR) light emitting diode (LED) lighting part according to an embodiment of the present invention; and

FIG. 5 is a view of a state in which a region of the IR LED lighting part where no LEDs are installed, is inside the housing and diffused reflection is prevented.

### MODE OF THE INVENTION

The present invention will now be described more fully with reference to the accompanying drawings, in which exemplary embodiments of the invention are shown.

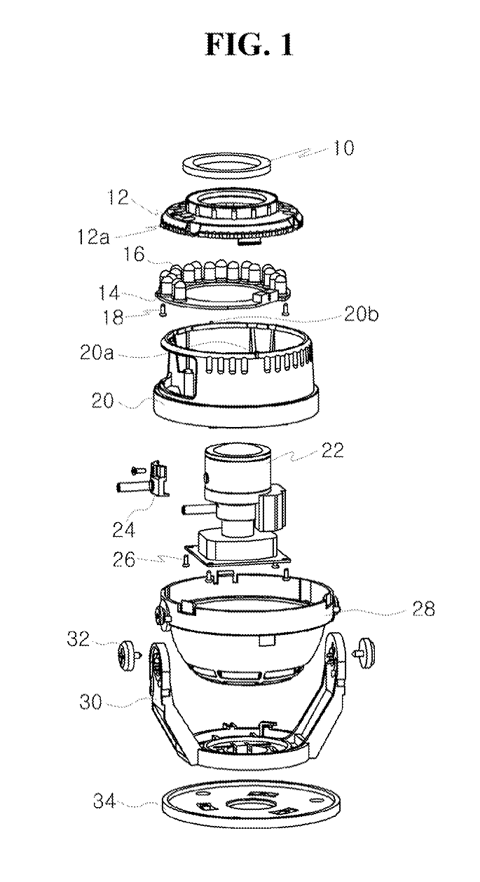

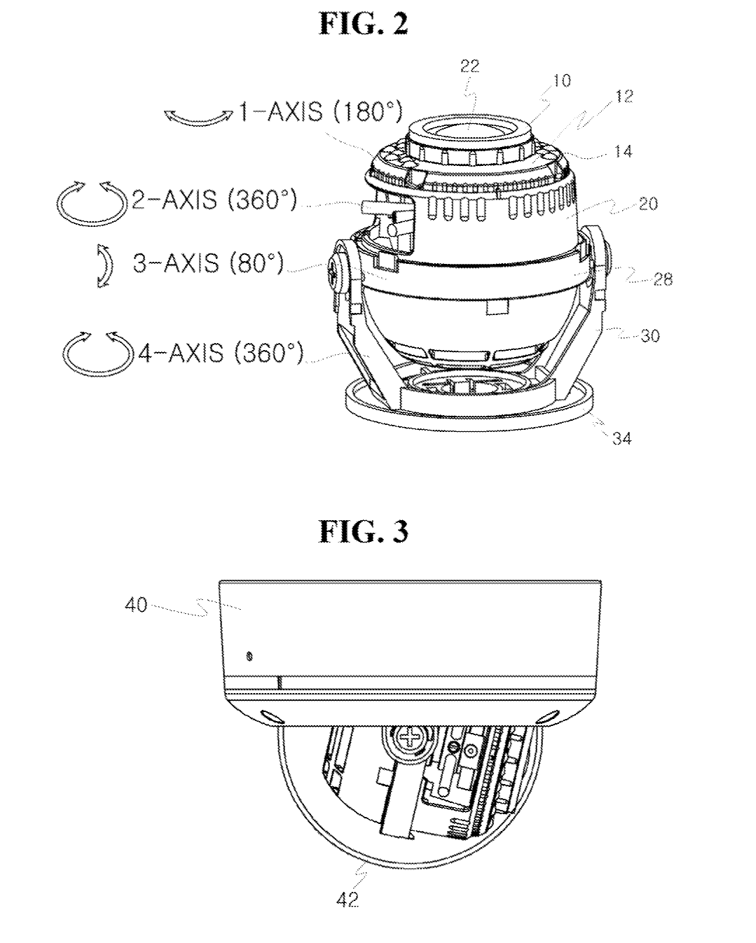

FIG. 1 is an exploded perspective view of a structure of a 4-axis monitoring camera to which a device for preventing diffused reflection of lighting for photography according to an embodiment of the present invention is applied, and FIG. 2 is a perspective view of a combined 4-axis driving state of the 4-axis monitoring camera to which the present invention is applied.

As illustrated in FIG. 1, the 4-axis monitoring camera to which the device for preventing diffused reflection of lighting for photography according to an embodiment of the present invention is applied, includes a lighting part cover 10, a lighting part bracket 12, an infrared (IR) light emitting diode (LED) lighting part 14, a lens part bracket 20, a lens part 22, a lens holder 24, a vertical rotation bracket 28, a horizontal rotation bracket 30, and a base bracket 34.

The IR LED lighting part 14 has a circular ring shape. A plurality of IR LEDs 16 are fixedly installed at a predetermined interval in regions other than a region of the circular ring part of the IR Led lighting part 14 where no LEDs are installed. The lighting part bracket 12 is inserted in an upper portion of the IR LED lighting part 14 so that the IR LED lighting part 14 is fixed in and combined with the lighting part bracket 12 using screws 18, and the lighting part cover 10 is inserted in and fixed to an upper portion of the lighting part bracket 12.

In a state in which the IR LED lighting part 14 is combined with the lighting part bracket 12, the lighting part bracket 12 is combined with the lens part bracket 20 disposed below the lighting part bracket 12 so as to be horizontally rotated at 180° clockwise/counterclockwise. The lens part 22 to which the lens holder 24 is screw-coupled, is accommodated in and is fixed in and combined with the lens part bracket 20 using screws 26.

Here, rotation protrusions 12a protrude from an outer edge of the lighting part bracket 12, i.e., from one side of a portion where the lighting part bracket 12 contacts the lens part bracket 20, and first and second stoppers 20a and 20b are installed at an outer edge of the lens part bracket 20 and face each other at an interval of 180°. Thus, progression of the rotation protrusions 12a is blocked by the first stopper 20a and the second stopper 20b so that a hanging action can be carried out with a rotation radius of 180°.

The lens part bracket 20 is combined with the vertical rotation bracket 28 disposed below the lens part bracket 20 so as to be horizontally rotated at 360° clockwise/counterclockwise. In a state in which the vertical rotation bracket 28 is rotatably combined with the lens part bracket 20, the vertical rotation bracket 28 is combined with both sides of the horizontal rotation bracket 30 using holder screws 32 so as to be vertically rotated at 80°.

The horizontal rotation bracket 30 is inserted in and combined with the base bracket 34 so as to be horizontally rotated at 360° clockwise/counterclockwise.

That is, as illustrated in FIG. 2, the lighting part bracket 12 that is a 1-axis rotation driving unit is driven in such a way that the IR LED lighting part 14 can be horizontally rotated at 180° clockwise/counterclockwise. The lens part bracket 20 that is a 2-axis rotation driving unit is driven in such a way that the lens part 22 and the lighting part bracket 12 including the IR LED lighting part 14 can be infinitely horizontally rotated at 360° clockwise/counterclockwise.

Also, the vertical rotation bracket 28 that is a 3-axis rotation driving unit is driven in such a way that the lens part bracket 20 including the lens part 22 and the lighting part bracket 12 including the IR LED lighting part 14 can be vertically rotated at an angle of 80°. The rotation angle of 80° of the vertical rotation bracket 28 is an angle considering a maximum viewing angle at which the lens part 22 can capture an image when a camera body is fixedly installed at a housing (see 40 of FIG. 3) and is rotated.

In addition, the horizontal rotation bracket 30 that is a 4-axis rotation driving unit is driven in such a way that the lens part bracket 20 including the lens part 22, the lighting part bracket 12 including the IR LED lighting part 14 and the vertical rotation bracket 28 are configured as a single camera body and can be infinitely horizontally rotated around the base bracket 34 at 360° clockwise/counterclockwise.

As illustrated in FIG. 3, in a state in which a body of the 4-axis monitoring camera in which the lighting part bracket 12, the lens part bracket 20, the vertical rotation bracket 28, and the horizontal rotation bracket 30 are configured as a single camera body, is fixedly mounted on the housing 40, the body of the 4-axis monitoring camera can be exposed in a semicircular, transparent hemisphere 42, and photographing of a surveillance region can be performed through the transparent hemisphere 42.

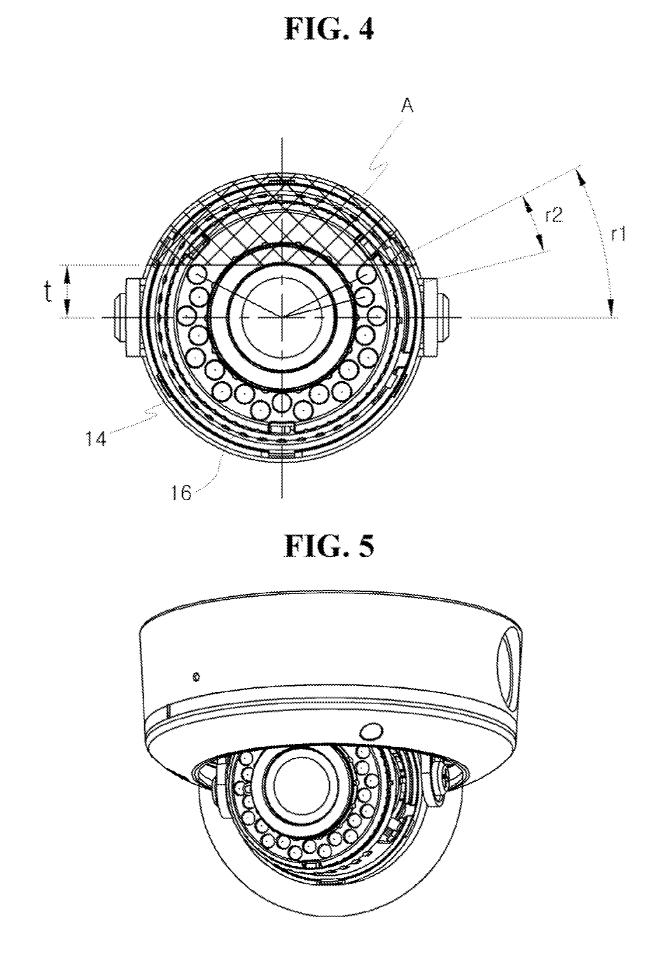

The IR LED lighting part 14 is configured in such a way that the plurality of IR LEDs 16 are installed along a circular ring part at a predetermined interval and no IR LEDs 16 are installed in a region corresponding to a blocking region A that exists within the housing 40 when the vertical rotation bracket 28 is rotated at a maximum angle of 80°, as illustrated in FIG. 4.

That is, the blocking region A is a region of the circular ring part of the IR LED lighting part 14 that escapes from a horizontal position of a center of the circular ring part at a predetermined interval t in a region in an upward direction of a rotation shaft. Thus, when the IR LEDs 16 are installed at the circular ring part of the IR LED lighting part 14 at an angle r2 at a predetermined interval, the IR LEDs 16 are installed up to a region that corresponds to an angle r1 corresponding to the predetermined interval t from the horizontal position of the center of the circular ring part, and no IR LEDs 16 are installed in the blocking region A that escapes from the angle r1.

Here, when a diameter of the circular ring part of the IR LED lighting part 14 is 62.8 mm, the predetermined interval t may be in the range of 13.2 to 15.2 mm (preferably, 14.2 mm), the angle r2 may be set to 17° to 13°, and the angle r1 may be set to 25° to 30° (preferably, 27.0°).

Thus, as illustrated in FIG. 5, although the camera body fixed to the housing 40 is rotated at 80° that is a maximum angle of the vertical rotation bracket 28 and portions of the IR LED lighting part 14 are inserted into the housing 40, since a region to match an insertion region within the housing 40 is the blocking region A in which no LEDs 16 are installed, diffused reflection does not occur due to LED light so that the lens part 22 can perform normal surveillance photographing.

Here, the rotation protrusions 14 formed at the outer edge of the lighting part bracket 12, and the first and second stoppers 20a and 20b formed at the outer edge of the lens part bracket 20 limit the IR LED lighting part 14 to be rotated within an angle of 180° so that cables connected between the IR LEDs 16 and the lens part 22 do not get twisted.

### INDUSTRIAL APPLICABILITY

As described above, according to the present invention, in a monitoring dome type camera having a 4-axis driving method in which vertical rotation and horizontal rotation of a camera body, horizontal rotation of a lens part and horizontal rotation of an IR LED lighting part can be performed, LEDs installed in regions from among a plurality of IR LEDs of the IR LED lighting part arranged along a circular part of a lens part for night-time lighting of the lens part are removed so that a region of the IR LED lighting part from which the LEDs are removed, can match an insertion region within the housing when the camera is rotated. Thus, diffused reflection that may occur due to the IR LEDs when the camera is rotated, can be completely removed so that a surveillance image with a normal quality can be obtained and a viewing angle for photography of the lens part of the camera can be widened and thus surveillance blind spots can be removed.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A device for preventing diffused reflection of lighting for photography using a monitoring camera in which a camera body in which horizontal rotation of a lens part bracket including a lens part clockwise/counterclockwise, vertical rotation of a vertical rotation bracket and horizontal rotation of a horizontal rotation bracket clockwise/counterclockwise are performed, is fixed to a housing, the device comprising:
a light emitting diode (LED) lighting part comprising a plurality of infrared (IR) LEDs disposed along a circular ring part at a predetermined interval and forming a blocking region in which no IR LEDs are installed to match an insertion region within the housing when the LED lighting part is rotated at a maximum angle due to vertical rotation of the vertical rotation bracket; and
a lighting part bracket in which the LED lighting part is accommodated and is fixed and which is horizontally rotated clockwise/counterclockwise so that the blocking region formed in the LED lighting part exists within the housing when the camera body is multi-axis rotated for monitoring.

2. The device of claim 1, wherein a maximum angle of horizontal rotation due to 3-axis rotation of the vertical rotation bracket is 80°.

3. The device of claim 1, wherein rotation protrusions are formed at an outer edge of the lighting part bracket, and first and second stoppers are formed at an outer edge of the lens part bracket and face each other at an interval of 180° so as to block progression of the rotation protrusions.

4. The device of claim 1, wherein, when a diameter of the circular ring part of the LED lighting part is 62.8 mm, the blocking region of the LED lighting part is a region of the circular ring part of the IR LED lighting part that escapes from a horizontal position of a center of the circular ring part at an interval in a range of 13.2 to 15.2 mm in a region in an upward direction of a rotation shaft or a region that escapes from the horizontal position of the center of the circular ring part at an interval of 25° to 30° in the region in the upward direction of the rotation shaft.
